(19) United States
(12) Patent Application Publication
(10) Pub. No.: US 2007/0035524 A1
(43) Pub. Date: Feb. 15, 2007

(54) Methods, electronic devices and computer program products for controlling a touch screen

(75) Inventor: Edward Craig Hyatt, Durham, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/199,911

(22) Filed: Aug. 9, 2005

(51) Int. Cl. G09G 5/00

(52) U.S. Cl. 345/173

(57) ABSTRACT

Methods for controlling a touch screen of an electronic device include: providing a soft key on the touch screen; determining an update triggering event; and, responsive to the update triggering event, relocating the soft key and/or a label of the soft key from a first location on the touch screen to a second location on the touch screen, displaced from the first location.

### FIELD OF THE INVENTION

The present invention relates to electronic devices and, more particularly, to electronic devices including touch screens.

### BACKGROUND OF THE INVENTION

A variety of electronic devices, such as mobile terminals (e.g., cellphones, personal digital assistants (PDAs) and/or laptop computers), include touch screen systems (also referred to as touch sensitive displays). These touch screen systems are relied upon for data input and manipulation. Typically, a touch screen system includes a touch sensitive sensor device that overlies a display screen of the electronic device. The touch sensitive device is operably connected to a computer that receives and processes signals from the touch sensitive device. Such signals are generated by the touch sensitive device responsive to detection of touches on the touch sensitive device by a user.

Images displayed on the display screen are viewable through the touch sensitive device. In particular, the electronic device may generate and enable one or more soft keys. Each soft key includes an image (e.g., a button graphic) that is displayed on the display screen and viewable through the touch sensitive device. The region of the touch sensitive device overlying the soft key image is designated by the computer as “activated”, such that suitable touches in this region are registered as corresponding actuations of the soft key. Various touch screen technologies are available, including resistive, capacitive, surface acoustic wave (SAW), and infrared (IR) touch screens. These different technologies vary in the way that the touch is detected.

### SUMMARY OF THE INVENTION

According to embodiments of the present invention, methods for controlling a touch screen of an electronic device include: providing a soft key on the touch screen; determining an update triggering event; and, responsive to the update triggering event, relocating the soft key and/or a label of the soft key from a first location on the touch screen to a second location on the touch screen, displaced from the first location.

Relocating the soft key and/or a label of the soft key may include relocating the soft key from the first location on the touch screen to the second location on the touch screen. The method may further include displaying an image element on the touch screen, wherein relocating the soft key includes relocating the image element on the touch screen along with the soft key such that the relative positions of the image element and the soft key are maintained. According to some embodiments, a second soft key is provided on the touch screen, wherein the second soft key includes the image element, and relocating the image element includes relocating the second soft key on the touch screen along with the first soft key such that the relative positions of the first and second soft keys are maintained. The method may further include generating a screen display image and an adjacent buffer image on the touch screen, the screen image including the soft key and the image element, wherein relocating the soft key includes moving the entirety of the screen display image relative to the touch screen and the buffer image.

According to some embodiments, the first and second locations are non-overlapping. According to some embodiments, the first and second locations are overlapping. According to some embodiments, the overlap area between the first and locations is in the range of from about 10 to 90 percent of the area of the soft key in the first location.

According to some embodiments, the soft key includes the label and relocating the soft key and/or the label of the soft key includes relocating the label in the soft key on the touch screen.

According to some embodiments, the soft key comprises a button, a check box, an interactive menu, and/or a text edit box.

According to some embodiments, the method includes detecting user actuations of the soft key, wherein the update triggering event comprises detection of a number of user actuations of the soft key.

According to some embodiments, the update triggering event includes elapse of a predetermined time period. According to some embodiments, the update triggering event includes the touch screen entering and/or exiting a power-saving sleep mode. According to some embodiments, the update triggering event includes the touch screen powering on and/or off.

According to some embodiments, the method includes repeatedly relocating the soft key and/or a label of the soft key on the touch screen. According to some embodiments, the method includes repeatedly relocating the soft key and/or a label of the soft key on the touch screen at a rate selected to cause the relocations of the soft key and/or the label to appear to a user as continuous. The method may further include providing a user interface display associated with a selected operating condition of the electronic device, the user interface display including the soft key, wherein relocating the soft key and/or a label of the soft key includes relocating the soft key from the first location on the touch screen to the second location on the touch screen while the electronic device is in the selected operating condition.

According to further embodiments of the present invention, an electronic device includes a touch screen and a processor. The processor is configured to: provide a soft key on the touch screen; determine an update triggering event; and, responsive to the update triggering event, relocate the soft key and/or a label of the soft key from a first location on the touch screen to a second location on the touch screen, displaced from the first location.

According to further embodiments of the present invention, a computer program product for controlling a touch screen of an electronic device includes a computer usable medium having computer usable program code embodied therein, the computer usable program code including: computer usable program code configured to provide a soft key on the touch screen; computer usable program code configured to determine an update triggering event; and computer usable program code configured to relocate the soft key and/or a label of the soft key from a first location on the touch screen to a second location on the touch screen, displaced from the first location, responsive to the update triggering event.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a flowchart illustrating methods in accordance with some embodiments of the present invention.

FIG. 2 is a schematic diagram of a mobile terminal according to some embodiments of the present invention and an exemplary base station transceiver.

FIG. 3 is a front plan view of the mobile terminal of FIG. 2 including a first touch screen configuration in accordance with some embodiments of the present invention.

FIG. 4A is a front plan view of the mobile terminal of FIGS. 2 and 3 including a second touch screen configuration in accordance with some embodiments of the present invention.

FIG. 4B is a front plan view of the mobile terminal of FIG. 4A including a third touch screen configuration in accordance with further embodiments of the present invention.

FIG. 5 is a front plan view of the mobile terminal of FIGS. 2 and 3 including a fourth touch screen configuration in accordance with further embodiments of the present invention.

FIG. 6 is a front plan view of the mobile terminal of FIGS. 2 and 3 including a fifth touch screen configuration in accordance with further embodiments of the present invention.

FIG. 7 is a front plan view of the mobile terminal of FIG. 1 including a sixth touch screen configuration in accordance with further embodiments of the present invention.

FIG. 8 is a front plan view of the mobile terminal of FIGS. 1 and 7 including a seventh touch screen configuration in accordance with further embodiments of the present invention.

FIG. 9 is a front plan view of the mobile terminal of FIGS. 2 and 3 including a eighth touch screen configuration in accordance with further embodiments of the present invention.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein the term “and/or” includes any and all combinations of one or more of the associated listed items. It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Furthermore, “coupled” or “connected” as used herein may include wirelessly coupled or connected.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. As used herein the term “adjacent” means close to or lying near but not necessarily touching.

Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, electronic devices, and/or computer program products. Accordingly, the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language and/or a lower level assembler language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider). It will be further appreciated that the functionality of any or all of the program modules may also be implemented using discrete hardware components, one or more application specific integrated circuits (ASICs), or a programmed digital signal processor or microcontroller.

The present invention is described hereinafter with reference to flowchart and/or block diagram illustrations of methods, mobile terminals, electronic devices, data processing systems, and/or computer program products in accordance with some embodiments of the invention.

These flowchart and/or block diagrams further illustrate exemplary operations for controlling a touch screen of an electronic device in accordance with various embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

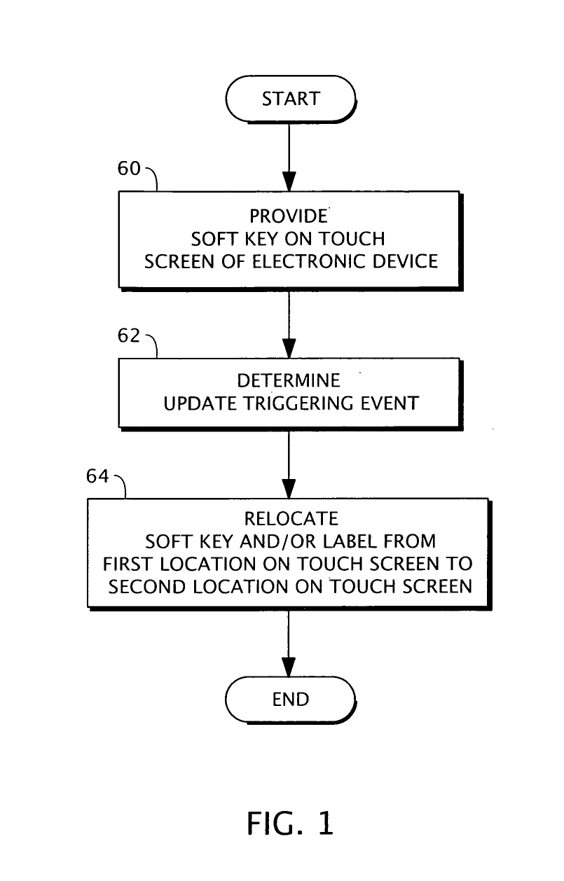

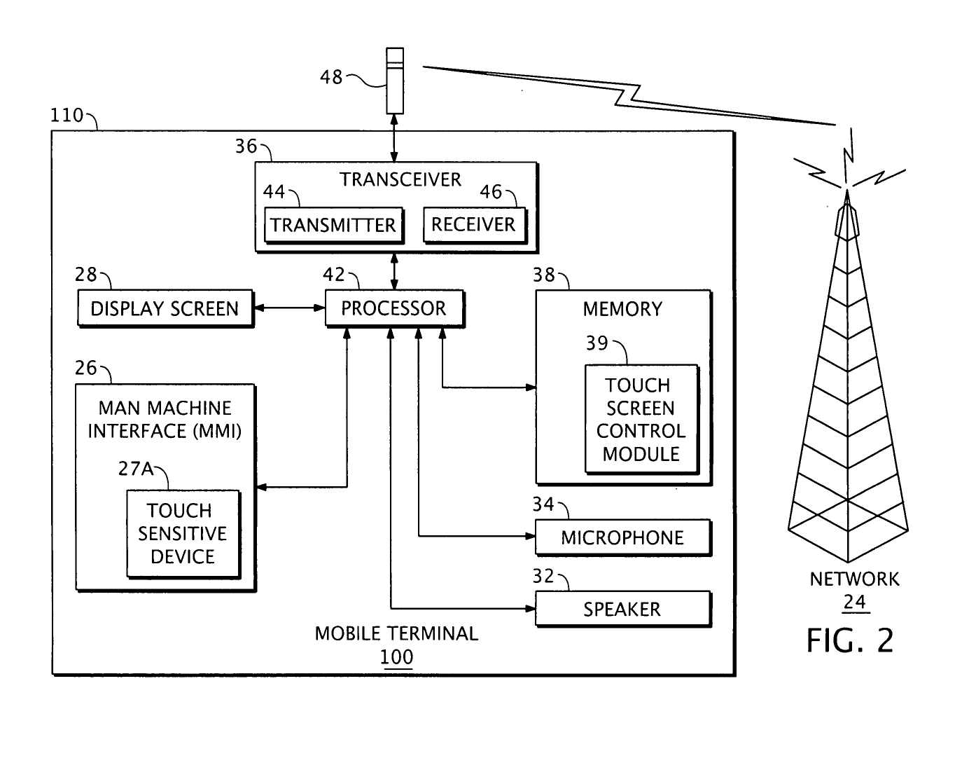

The diagrams of FIGS. 1 and 2 illustrate the architecture, functionality, and operations of some embodiments of methods, systems, and computer program products for controlling a touch screen of an electronic device. In this regard, each block may represent a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

As used herein, “electronic component” means an active device as contrasted with a passive electrical connector or the like. An electronic component may include a processor.

As used herein, “touch screen” refers to a display screen (e.g., a liquid crystal display (LCD) or cathode ray tube (CRT)) in combination with a touch sensitive device as described herein.

As used herein, “soft key” refers to a virtual user interactive element including, in combination, an image element displayed and viewable on a touch screen and an activated region of the touch screen corresponding to the image element. The activated region is recognized by an associated processor coupled to the touch screen as corresponding to the soft key such that, when the activated region is suitably engaged by a user (e.g., by touching the touch screen in the activated region), the processor registers actuation of the soft key.

A method for controlling a touch screen of an electronic device according to some embodiments of the present invention will now be described with reference to the flowchart of FIG. 1. Referring to the embodiments of FIG. 1, the method includes providing a soft key on the touch screen (Block 60). An update triggering event is then determined (Block 62). Responsive to the update triggering event, the soft key and/or a label of the soft key is then relocated from a first location on the touch screen to a second location on the touch screen, displaced from the first location, to facilitate a more even and/or wider distribution on the touch screen of user contacts with the touch screen to actuate the soft key (Block 64). In this way, the method serves to enhance distribution of degradation from wear or dirt accumulation on the touch screen which may result from user actuation of the soft key.

Some embodiments of the present invention will now be described below with respect to FIGS. 2-9. Some embodiments of the present invention provide electronic devices in which the soft keys or soft key labels are automatically moved or rotated on a touch screen so as to more uniformly and/or widely distribute touches, which may reduce wear on the touch screen. This may increase the life span of the electronic device.

The present invention is described below with reference to schematic and block diagrams of electronic devices including touch screens according to some embodiments of the present invention. Although the electronic devices are discussed herein as being included as part of a mobile wireless communication terminal, for example, the mobile terminal 100 of FIGS. 2-9, embodiments of the present invention are not limited to this configuration. As discussed below, various aspects of the present invention may be incorporated into other types of devices including, for example, mobile devices that are not wireless communication terminals or non-portable electronic devices, without departing from the scope of the present invention.

Referring now to FIG. 2, an exemplary radiotelephone communication system in accordance with some embodiments of the present invention is illustrated. The system includes the mobile wireless communication terminal 100 and a base station transceiver, which is part of a wireless communications network 24. In some embodiments of the present invention, the network 24 includes a base station transceiver that includes the radio transceiver(s) that define an individual cell in a cellular network and communicates with the mobile terminal 100 and other mobile terminals in the cell using a radio-link protocol. It will be understood that, in some embodiments of the present invention, many base station transceivers may be connected through, for example, a mobile switching center and other devices to define the wireless communications network 24.

The mobile terminal 100 in the illustrated embodiments includes a portable housing assembly 110, a processor 42, a man machine interface (MMI) 26, a display screen 28, a speaker 32, a microphone 34, a transceiver 36, and a memory 38 including application information and parameters, any of which may communicate with the processor 42. The foregoing components of the mobile terminal 100 may be included in many conventional mobile terminals and their functionality is generally known to those skilled in the art. The mobile terminal 100 further includes a touch screen control module 39 which may be stored in the memory 38 as illustrated.

The display screen 28 may be any suitable display screen assembly. For example, the display screen 28 may be a liquid crystal display (LCD) with or without auxiliary lighting (e.g., a lighting panel). The display screen 28 will typically include a substantially rigid panel, which may be formed of transparent glass or plastic.

The MMI 26 includes a touch activated or touch sensitive device 27A as discussed in more detail below. The MMI 26 may further include any other suitable input device(s) including, for example, a joystick, a keyboard/keypad, a dial, a directional key or keys, and/or a pointing device (such as a mouse, trackball, touch pad, etc.).

The touch sensitive device 27A may include one or more layers that overlie the display screen 28 and may be integrated therewith. The touch sensitive device 27A is adapted to be touched or pressed by a suitable member such as a stylus or an operator's finger. The touch screen system may include a controller card to drive the touch sensitive device 27A and convert touches into x-y coordinates, a software driver program that communicates between the controller card and the operating system of the computer of the electronic device 100, and a software application (including the touch screen control module 39) adapted to enable, monitor and process signals from the touch sensitive device 27A. Several different touch technologies are available including resistive, capacitive, surface acoustic wave (SAW) and infrared (IR). These different technologies vary in the way that the touch is detected.

According to some embodiments, the touch sensitive device 27A is a resistive system. In this case, the touch sensitive device 27A typically will include two layers of conductive material held apart by spacers. The two layers are typically transparent. The layers may be supported or backed by the display screen 28. An electrical current runs across the two layers. When the user touches the touch screen surface (e.g., using a finger or stylus), the touch pressure causes the two layers to contact one another. A change in the electrical field allows the contact area to be detected and the computer then calculates the coordinates of the point of contact. Identification of the coordinates allows a driver/controller associated with the touch sensitive device 27A to translate or convert the touch into information that the user interface logic of the electronic device can understand.

According to some embodiments, the touch sensitive device 27A is a capacitive system. In this case, a capacitive layer overlies the display screen 28. The capacitive layer is typically transparent. The layers may be supported or backed by the display screen 28. The touch sensitive device 27A utilizes the conductivity of a user's finger to transfer some of the charge that is stored on the surface of the capacitive layer to the user's body. This results in a decrease in the charge in the capacitive layer or surface of the touch screen, which is measured (e.g., in circuits at each corner of the touch screen). The relative charges at each corner are calculated by the processor, which indicates where the touch occurred on the touch screen. This information is then relayed to the touch screen driver software.

It is further contemplated that the touch sensitive device 27A may include a surface acoustic wave (SAW) system, a scanning infrared (IR) system, a combination of two or more touch screen systems, and/or any other suitable touch screen system. However, it will be appreciated from the description herein that the present invention may be particularly beneficial in the case where the touch sensitive device 27A is a resistive or capacitive type touch sensitive device.

In use, the processor 42 of the device 100 generates a display image on the display screen 28, which is viewable through the touch sensitive device 27A. The processor also generates one or more soft keys. Each soft key includes an image component that forms a part of the display image. Additionally, the processor activates a region corresponding to the image component such that, when a touch is detected by the touch sensitive device 27A in the activated region, the processor registers the soft key as being actuated in accordance with the properties of the soft key and the characteristics of the touch. For example, if the soft key is a virtual button, the soft key image component will emulate a physical button and, when the touch sensitive device 27A is suitably touched in the region overlying the image component, the processor will register the virtual button as having been actuated.

Similarly, if the soft key is a data entry box, the soft key image component will appear as an entry field and a user may write text or images in the entry field using a stylus or the like on the touch sensitive device 27A in the activated region indicated by the image component. The text or images indicated by the user's strokes on the touch sensitive device 27A will be received and processed. Typically, the activated region will be coextensive with the image component.

The transceiver 36 typically includes a transmitter circuit 44 and a receiver circuit 46, which respectively transmit outgoing radio frequency signals to the network 24 and receive incoming radio frequency signals, such as voice and data signals, from the network 24 via an antenna 48. The antenna 48 may be an embedded antenna, a retractable antenna or any antenna known to those having skill in the art without departing from the scope of the present invention. The radio frequency signals transmitted between the mobile terminal 100 and the network 24 may include both traffic and control signals (e.g., paging signals/messages for incoming calls), which are used to establish and maintain communication with another party or destination. The radio frequency signals may also include packet data information, such as, for example, cellular digital packet data (CDPD) information. In addition, the transceiver 36 may include an infrared (IR) transceiver configured to transmit/receive infrared signals to/from other electronic devices via an IR port. The processor 42 may support various functions of the mobile terminal 100. The processor 42 can be any commercially available or custom microprocessor, for example.

The foregoing components of the mobile terminal 100 may be included in many conventional mobile terminals and their functionality is generally known to those skilled in the art. As used herein, the term “portable electronic device” or “mobile terminal” may include: a satellite or cellular radiotelephone with or without a multi-line display; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; a gaming device, an audio video player, and a conventional laptop and/or palmtop portable computer that may include a radiotelephone transceiver. As used herein, “mobile terminals” may be portable, transportable, installed in a vehicle (aeronautical, maritime, or land-based), or situated and/or configured to operate locally and/or in a distributed fashion at any other location(s) on earth and/or in space. As used herein, a “mobile device” includes mobile terminals as well as mobile devices that do not support wireless communications. Mobile terminals may also be referred to as “pervasive computing” devices.

For purposes of illustration, embodiments of the present invention are described herein in the context of a mobile terminal. It will be understood, however, that the present invention is not limited to such embodiments and may be embodied generally as any electronic device, mobile or stationary, that includes data storage functionality. Although the present invention may be embodied in mobile communication devices or systems, such as the mobile wireless communication terminal 100, certain embodiments of the present invention are not limited to such devices and/or systems. Rather, some embodiments of the present invention may include electronic devices that are not communications devices and/or are not portable, mobile or handheld. For example, in accordance with the present invention, an electronic device of the present invention may include a PDA, a kiosk, a grocery store check-out station, a bar code reader, a PC, a laptop computer or the like. Thus, it will be understood that the present invention is not limited to such embodiments and may be embodied generally as any electronic device, mobile or stationary, that includes touch screen functionality.

According to some embodiments and as illustrated in FIGS. 2-9, the mobile terminal 100 is a handheld (portable) mobile terminal. By “handheld mobile terminal,” it is meant that the outer dimensions of the mobile terminal are adapted and suitable for use by a typical operator using one hand. According to some embodiments, the total volume of the handheld mobile terminal 100 is less than about 200 cc. According to some embodiments, the total volume of the handheld terminal 100 is less than about 100 cc. According to some embodiments, the total volume of the handheld mobile terminal 100 is between about 50 and 100 cc. According to some embodiments, no dimension of the handheld mobile terminal 100 exceeds about 200 mm.

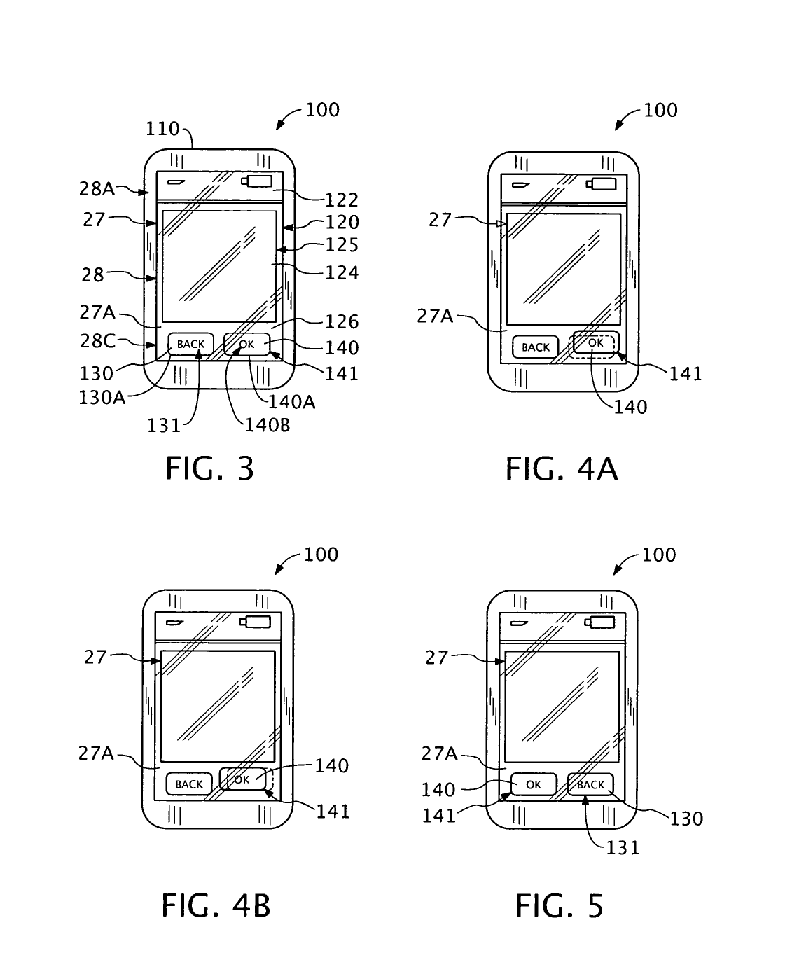

With reference to FIG. 3, the display screen 28 of the mobile terminal 100 may be considered as having an upper region 28A, an intermediate region 28B, and a lower region 28C. As shown in FIG. 3, an exemplary user interface display image 120 is generated on the display screen 28 of the mobile terminal 100. The display image 120 includes a status bar element 122 in the upper region 28A, a soft key data entry field or edit box element 124 in the intermediate region 28B, and soft key button elements 130, 140 in the lower region 28C. A border 126 surrounds the elements 124, 130, 140. As shown, the button elements 130, 140 each have a peripheral border 130A, 140A that defines the area of the respective button element. The button element 130 also includes a “Back” label within its periphery. The button element 140 also includes an “OK” label 140B within its periphery.

The edit box element 124 and its overlying activated region of the touch screen 27 are collectively referred to herein as an edit box soft key 125 (FIG. 3). The button element 130 and its overlying activated region of the touch screen 27 are collectively referred to herein as a button soft key 131. The button element 140 and its overlying activated region of the touch screen 27 are collectively referred to herein as a button soft key 141.

In use, a user interacts with the mobile terminal 100 using a finger, stylus or the like to actuate the soft keys 125, 131, 141 as discussed above. In doing so, the user will make repeated contact with the touch sensitive device 27A. In devices of the prior art, the soft key locations are generally static. Certain soft keys may be used more frequently and, in some cases, substantially more frequently, than other soft keys. As a result, disproportionate amounts of touches (i.e., “strikes” or “hits”) may be concentrated on the touch sensitive device 27A in the regions associated with these more frequently used soft keys. Over time, the touch sensitive device 27A in these areas may fail due to degradation from wear or dirt accumulation although remaining portions of the touch sensitive device 27A remain functional. Generally, even failure in a small area of the touch sensitive device 27A will be regarded as disabling of the touch screen. Touch screens utilizing resistive and capacitive systems are particularly prone to this problem because the sensors in these systems are on the touch sensitive device 27A itself. Some embodiments of present invention may provide a solution to this problem. More particularly, in accordance with some embodiments of the present invention, the soft keys are selectively relocated so that the strikes on the touch sensitive device 27A are more evenly distributed over a wider area on the touch sensitive device 27A.

In accordance with certain embodiments of the invention and with reference to FIGS. 3, 4A and 4B, the following process may be employed to distribute wear on the touch sensitive device 27A. The display image 120 is initially generated as shown in FIG. 3 with the “OK” button soft key 141 in a first location on the touch screen 27 as shown. The processor 42 determines that a triggering update event (e.g., an actuation count or an elapsed time period as discussed below) has occurred. The processor 42 selects a second location on the touch screen displaced or different from the first location. Thereafter, the display image 120 is reconfigured. More particularly, the “OK” button soft key 141 is relocated to the second location on the touch screen 27 from the first location as shown in FIG. 4A (the “OK” button soft key 141 is shown in dashed lines in the first position in FIG. 4A for reference). The “OK” button soft key 141 may thereafter be relocated to a third location as shown in FIG. 4B (the “OK” button soft key 141 is shown in dashed lines in the second position in FIG. 4B for reference). The “OK” button soft key 141 may thereafter be repeatedly relocated to a fourth location, a fifth location, etc., responsive to the determination of further respective update triggering events, each location being different from the one prior.

In practice, the relocation of the “OK” button soft key 141 as just described will tend to cause the user to more widely or evenly distribute strikes to the touch screen 27 because the user will typically tend to strike the button soft key 141 in the vicinity of the center of the button soft key 141. As the center of the soft key 141 moves about the touch screen 27, the user's hits directed to the soft key 141 will, thus, be distributed over a wider area. Such redistribution may result in an increase in the overall life of the touch screen and, as a result, the terminal 100 itself. The relocation of the soft key 141 may also improve the reliability of the soft key 141 as sensors fail or dirt accumulates on the touch screen 27.

The method of determining the update triggering event and initiating the relocation of the soft key 141 can be accomplished in any suitable manner, including one or more of the following. According to some embodiments, the soft key 141 is automatically relocated (i.e., without requiring user input deliberately relocating the soft key). The soft key 141 may be automatically relocated following a set number of user strikes or actuations of the soft key 141 or the overall touch screen 27. The soft key 141 may be automatically relocated following an elapsed period of time. The soft key 141 may be automatically relocated in response to the device 100 entering and/or exiting a power-saving sleep mode. The soft key 141 may be automatically relocated in response to the device 100 powering on and/or off. The elapsed time interval and/or actuation count trigger values may be constant (e.g., a specified number) or varied according to an algorithm or randomly. According to other embodiments, the soft key 141 is relocated responsive to a deliberate request by the user to relocate the soft key 141.

As illustrated in FIG. 4A, the footprint of the button soft key 141 in the first location overlaps the footprint of the button soft key 141 in the second location. According to some embodiments, the area of overlap between the footprints in each successive position is between about 10 and 90 percent of the area of the soft key in the first location. According to some embodiments, the minimum overlap area between any two positions of the soft key 141 is at least 10 percent and, according to some embodiments, at least 50 percent. According to other embodiments, the soft key 141 is relocated such that the footprint of the soft key 141 in a given location does not overlap the footprint of the soft key 141 when in another location (e.g., in the next successive location). According to some embodiments, the soft key 141 rotates along a circular path or the like.

According to some embodiments, it is desirable to minimize the rearrangement of the display image 120 in order to minimize potential confusion or annoyance to the user. According to some embodiments, all or some of the remaining image elements (e.g., elements 122, 124, 130) are maintained in their original positions as the “OK” button soft key 141 (including its image element 140) is relocated. According to some embodiments, the soft key 141 is automatically relocated on the touch screen at a rate and in such a way that each movement of the soft key 141 is substantially imperceptible to the user and the movement thus appears to the user to be continuous.

With reference to FIGS. 3 and 5, in accordance with further embodiments of the present invention, the following process may be employed to distribute wear on the touch sensitive device 27A. The display image 120 is initially generated as shown in FIG. 3 with the “OK” button soft key 141 in a first location on the touch screen 27 and the “Back” button soft key 131 in a second location as shown. Thereafter, the “OK” soft key 141 and the “Back” soft key 131 are each relocated on the touch screen 27 such that each is moved to substantially the location previously occupied by the other as shown in FIG. 5 (i.e., the button soft keys 131, 141 are interchanged or swapped). This method may allow for switching of the location of soft keys that are frequently used with ones that are less frequently used, thereby spreading the wear of the more frequently used soft keys between two distinct positions on the touch screen 27. Relocation of the soft keys 131, 141 in this manner may be initiated in any of the ways discussed above and the soft keys 131, 141 may be repeatedly swapped.

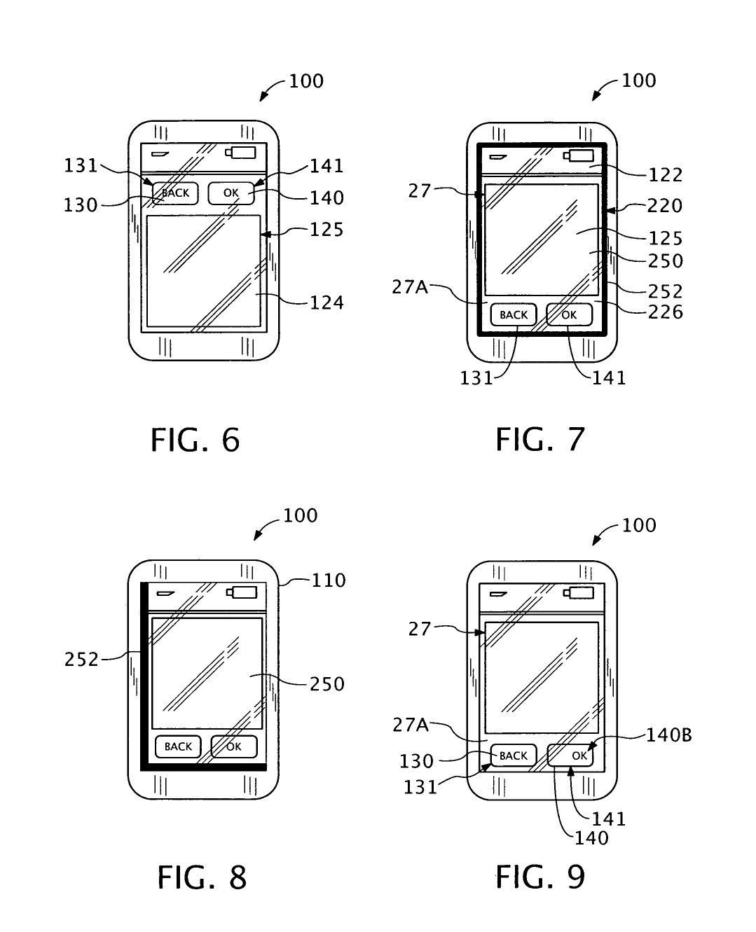

With reference to FIGS. 3 and 6, in accordance with further embodiments of the present invention, the following process may be employed to distribute wear on the touch sensitive device 27A. The display image 120 is initially generated as shown in FIG. 3 with the “OK” button soft key 141 and the “Back” button soft key 131 located below the edit box soft key 125 on the touch screen 27 as shown. Thereafter, the button soft keys 131, 141 and the edit box soft key 125 are each relocated on the touch screen 27 such that button soft keys 131, 141 are positioned above the edit box soft key 125, which is shifted downward, as shown in FIG. 6 (i.e., the button soft keys 131, 141 and the edit field soft key 125 are relatively inverted). This method may be used in order to maintain the positions of the button soft keys 131, 141 relative to one another while also relocating the soft keys 125, 131, 141 and thereby encouraging more uniform and wide distribution of soft key strikes. Relocation of the soft keys 125, 131, 141 in this manner may be initiated in any of the ways discussed above and the soft keys 125, 131, 141 may be repeatedly swapped.

With reference to FIGS. 7 and 8, in accordance with further embodiments of the present invention, the following process may be employed to distribute wear on the touch sensitive device. A modified display image 220 is initially generated as shown in FIG. 7 with a display image element 250 surrounded by a buffer image element 252. The buffer image element 252 may be colored so as to blend with the housing 110 and/or the border 226. The display image 220 otherwise corresponds to the display image 120 and includes the button soft keys 131, 141, the edit box soft key 125, and the status bar element 122. In use, the display image element 250 shifts relative to the touch screen 27 such that the display image element 250 is relocated from a first location (as shown in FIG. 7) to a second location (as shown in FIG. 8). According to some embodiments, the display image element 250 is otherwise unchanged. The configuration of the buffer image element 252 may also be revised to accommodate the shift of the display image element 250, as shown in FIG. 8.

This embodiment may be beneficial in that it maintains the relative relationships of the all or a selected group of the visual and active (e.g., soft key) elements of the display image 220 while also relocating the soft keys 125, 131, 141 and thereby encouraging more even and wide distribution of soft key strikes. Relocation or shifting of the display image element 250 in this manner may be initiated in any of the ways discussed above and the display image element 250 may be repeatedly shifted. According to some embodiments, the display image element 250 is shifted along a circular path.

With reference to FIGS. 3 and 9, in accordance with further embodiments of the present invention, the following process may be employed to distribute wear on the touch sensitive device. The display image 120 is initially generated as shown in FIG. 3. Thereafter, the “OK” label 140B of the “OK” button soft key 141 is relocated on the touch screen 27 from a first location (as shown FIG. 3) to a second location (as shown in FIG. 9). According to some embodiments and as shown, the “OK” label 140B is positioned within the peripheral border 140A of the button soft key 141 in each location. This method may be used in order to maintain the positions of the button soft key 141 in the same physical position relative to the display screen 28 and/or the other soft keys and image elements while still encouraging more even and wide distribution of soft key strikes. More particularly, the user may tend to target the “OK” label 140B (which serves as the “psychological center” of the button element 140) such that the distribution of the user's strikes shifts along with the “OK” label 140B. Relocation of the “OK” label 140B in this manner may be initiated in any of the ways discussed above and “OK” label 140B may be repeatedly relocated. The label positions may be partially overlapping or entirely non-overlapping.

As described above, the soft keys that are relocated in accordance with embodiments of the invention may include virtual buttons, edit boxes (e.g., text edit boxes) or like graphical user interface (GUI) objects. Other suitable soft keys, such as interactive menus, check boxes, scroll bars, etc. can also be relocated as described herein in accordance with embodiments of the invention.

It will be appreciated that the various configurations of display images and soft keys described above are merely illustrative. Additionally, various of the foregoing methods and techniques for relocating soft keys and/or soft key labels may be used in combination.

The application programs described herein, including the touch screen control module 39, are illustrative of programs that implement various features according to embodiments of the present invention. It will be appreciated that other and/or additional application programs may be employed in accordance with embodiments of the present invention.

While electronic devices according to the invention are discussed above utilizing touch sensitive device 27A having sensor layers overlying a display screen, aspects of the present invention may also be beneficially employed in devices utilizing SAW, IR, and other types of touch sensitive device not requiring contact with the touch sensitive device. For example, in order to reduce wear on the display screen itself or an overlying layer (e.g., an anti-glare film or coating), it may be desirable to more evenly distribute the user strikes in the display screen.

According to some embodiments, each of the soft keys as described herein retains its continuity of identity or linkage to a specific functionality as it is relocated from the first location to the second location, etc., on the touch screen 27. According to some embodiments, the user interface display (e.g., the display image 120 or 250) is associated with a given operating condition (i.e., state or mode) of the electronic device and, as illustrated, the soft key is relocated from the first location to the second location while maintaining the electronic device in the same operating condition.

Although FIG. 2 illustrates an exemplary hardware/software architecture that may be used in mobile terminals and/or other electronic devices for controlling a touch screen, it will be understood that the present invention is not limited to such a configuration but is intended to encompass any configuration capable of carrying out operations described herein. For example, although the memory 38 is illustrated as separate from the processor 42, the memory 38 or portions thereof may be considered as a part of the processor 42. More generally, while particular functionalities are shown in particular blocks by way of illustration, functionalities of different blocks and/or portions thereof may be combined, divided, and/or eliminated. Moreover, the functionality of the hardware/software architecture of FIG. 2 may be implemented as a single processor system or a multi-processor system in accordance with various embodiments of the present invention.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that is should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

That which is claimed is:

1. A method for controlling a touch screen of an electronic device, the method comprising:
providing a soft key on the touch screen;
determining an update triggering event; and
responsive to the update triggering event, relocating the soft key and/or a label of the soft key from a first location on the touch screen to a second location on the touch screen, displaced from the first location.

2. The method of claim 1 wherein relocating the soft key and/or a label of the soft key comprises relocating the soft key from the first location on the touch screen to the second location on the touch screen.

3. The method of claim 2 further comprising displaying an image element on the touch screen, wherein relocating the soft key comprises relocating the image element on the touch screen along with the soft key such that the relative positions of the image element and the soft key are maintained.

4. The method of claim 3 further comprising providing a second soft key on the touch screen, wherein the second soft key includes the image element, wherein relocating the image element comprises relocating the second soft key on the touch screen along with the first soft key such that the relative positions of the first and second soft keys are maintained.

5. The method of claim 3 further comprising generating a screen display image and an adjacent buffer image on the touch screen, the screen image including the soft key and the image element, wherein relocating the soft key comprises moving the entirety of the screen display image relative to the touch screen and the buffer image.

6. The method of claim 2 wherein the first and second locations are non-overlapping.

7. The method of claim 2 wherein the first and second locations are overlapping.

8. The method of claim 7 wherein the overlap area between the first and locations is in the range of from about 10 to 90 percent of the area of the soft key in the first location.

9. The method of claim 1 wherein:
the soft key includes the label; and
relocating the soft key and/or the label of the soft key comprises relocating the label in the soft key on the touch screen.

10. The method of claim 1 wherein the soft key comprises a button, a check box, an interactive menu, and/or a text edit box.

11. The method of claim 10 wherein the soft key comprises a button.

12. The method of claim 1 comprising detecting user actuations of the soft key, wherein the update triggering event comprises detection of a number of user actuations of the soft key.

13. The method of claim 1 wherein the update triggering event comprises elapse of a predetermined time period.

14. The method of claim 1 wherein the update triggering event comprises the touch screen entering and/or exiting a power-saving sleep mode.

15. The method of claim 1 wherein the update triggering event comprises the touch screen powering on and/or off.

16. The method of claim 1 comprising repeatedly relocating the soft key and/or a label of the soft key on the touch screen.

17. The method of claim 16 comprising repeatedly relocating the soft key and/or a label of the soft key on the touch screen at a rate selected to cause the relocations of the soft key and/or the label to appear to a user as continuous.

18. The method of claim 17 comprising providing a user interface display associated with a selected operating condition of the electronic device, the user interface display including the soft key, wherein relocating the soft key and/or a label of the soft key comprises relocating the soft key from the first location on the touch screen to the second location on the touch screen while the electronic device is in the selected operating condition.

19. An electronic device comprising:
a touch screen; and
a processor configured to:
provide a soft key on the touch screen;
determine an update triggering event; and
responsive to the update triggering event, relocate the soft key and/or a label of the soft key from a first location on the touch screen to a second location on the touch screen, displaced from the first location.

20. A computer program product for controlling a touch screen of an electronic device, the computer program product comprising:
a computer usable medium having computer usable program code embodied therein, the computer usable program code comprising:
computer usable program code configured to provide a soft key on the touch screen;
computer usable program code configured to determine an update triggering event; and
computer usable program code configured to relocate the soft key and/or a label of the soft key from a first location on the touch screen to a second location on the touch screen, displaced from the first location, responsive to the update triggering event.
